(19) United States
(12) Patent Application Publication
(10) Pub. No.: US 2023/0244509 A1
(43) Pub. Date: Aug. 3, 2023

(54) VIRTUAL PROCESSING DEVICE FOR CONTROLLING AN OPERATING INTERFACE OF A GUEST VIRTUAL MACHINE

(71) Applicant: Acer Incorporated, New Taipei City (TW)

(72) Inventors: Kuan-Ju CHEN, New Taipei City (TW); Chao-Kuang YANG, New Taipei City (TW)

(73) Assignee: Acer Incorporated, New Taipei City (TW)

(21) Appl. No.: 18/099,567

(22) Filed: Jan. 20, 2023

(30) Foreign Application Priority Data
Jan. 28, 2022 (TW) 111104066

(51) Int. Cl. G06F 9/451; G06F 9/455

(52) U.S. Cl. CPC G06F 9/452; G06F 9/45558; G06F 2009/4557

(57) ABSTRACT

A virtual processing device, for controlling a displaying of a first operating interface of a first guest virtual machine, the virtual processing device comprises the following elements. A display and desktop generation unit, for receiving a graphic application and generating a virtual desktop creation command, the virtual desktop creation command is used to create a first virtual desktop to display the first operating interface with full-screen. A window management unit, for setting a display position at which the first operating interface is displayed on the first virtual desktop, according to the graphic application. A display and desktop management unit, for setting a display number and a desktop number related to the first guest virtual machine according to the virtual-desktop-creation-command, the desktop number corresponds to the first virtual desktop. The first operating interface and the host operating interface are switched to display on at least one displayer.

This application claims the benefit of Taiwan application Serial No. 111104066, filed Jan. 28, 2022, the subject matter of which is incorporated herein by reference.

### TECHNICAL FIELD

The present disclosure relates to a data processing device, in particular, relates to a virtual processing device for processing allocation of displaying and switching of operating interfaces of a guest virtual machine (“guest VM”).

### BACKGROUND

With the evolution of virtual technology in computer science, a virtual machine may be customized and deployed in a computing device, and the virtual device may be controlled by the virtual machine to access the corresponding physical hardware device. For example, a virtual machine may be deployed, in addition to the original host operating system of the computing device, to serve as a second operating system, so as to expand the convenience and diversity of the computing device.

In the prior arts, the user installs the second operating system in the virtual machine, however, the virtual machine has low privilege to access the host operating system, and the conventional virtual machine lacks window managing mechanism, hence the operating interface of the second operating system may not be displayed with full screen, furthermore, the second operating system and the host operating system may not be switched in a seamless manner.

In other prior arts, the user installs the second operating system in another disc region of the computing device, however, when the second operating system and the host operating system are switched, a reboot for the computing device is required. That is, the user may not switch at any time during the operation, thus greatly reducing the operating experience with smooth switching.

In addition, when releasing the device drivers, Microsoft Windows operating system (Windows OS) has a higher priority. The device drivers for operating systems (such as “Linux” operating systems) other than the Microsoft Windows operating system may not be ready until a half year later. That is, the user may not switch the host operating system (such as Microsoft Windows operating system) and the second operating system (such as “Linux” operating system) by rebooting the computing device, during the half-year waiting period. Moreover, if an additional display server is created according to the prior arts, the host operating system does not correspondingly create an additional virtual desktop or an additional display, therefore, at most one operating system may be created in additional to the original host operating system.

In view of the above-mentioned technical problems of the prior arts, skilled ones in related industries of this technical field are devoted to improve control mechanism for the display allocation and switching of the operating interfaces of the guest virtual machine, such that full-screen operating experience and seamlessly switching experience for the user may be satisfied, without need of rebooting the computing device.

### SUMMARY

According to an aspect of the present disclosure, a virtual processing device is provided. The virtual processing device is used to control a displaying of a first operating interface of a first guest virtual machine. The virtual processing device comprises the following elements. A display and desktop generation unit, for receiving a graphic application and generating a virtual desktop creation command, the virtual desktop creation command is used to create a first virtual desktop to display the first operating interface with full-screen. A window management unit, for setting a display position at which the first operating interface is displayed on the first virtual desktop, according to the graphic application. A display and desktop management unit, for setting a display number and a desktop number related to the first guest virtual machine according to the virtual-desktop-creation-command, the desktop number corresponds to the first virtual desktop. The first guest virtual machine concurrently operates with a host operating system, the host operating system has a host operating interface displayed on a default desktop, and the first operating interface and the host operating interface are switched to display on at least one displayer.

### BRIEF DESCRIPTION OF THE DRAWINGS

FIG. 1 is a schematic diagram illustrating a guest virtual machine (“guest VM”) 2000 operates in a computing device 1000.

FIG. 2A is a schematic diagram illustrating the operating interface 2100 of the guest virtual machine 2000 is displayed on the displayer 110.

FIGS. 2B and 2C are schematic diagrams illustrating display switching between the operating interface 2100 of the guest virtual machine 2000 and the host operating interface 3100 of the host operating system 3000.

FIG. 3 is a block diagram of a guest virtual processing device 200 according to an embodiment of the present disclosure.

FIG. 4 is a schematic diagram illustrating display allocation of the operating interface 2100 of the guest virtual machine 2000 controlled by the guest virtual processing device 200.

FIG. 5A is a block diagram of a guest virtual machine 2000, a guest kernel layer 2200 and a host kernel layer 3200.

FIG. 5B is a block diagram of a guest virtual machine 2000, a host operating system 3000 and physical devices 1500.

FIGS. 6A-6C are schematic diagrams showing respective operating interfaces 3100, 2100 and 2102 of the host operating system 3000, the guest virtual machine 2000 and the guest virtual machine 2002 are respectively displayed on different displayers and different virtual desktops of the computing device 1000.

FIG. 6D is a schematic diagram illustrating display switching of the operating interfaces 3100, 2100 and 2102 of the host operating system 3000, the guest virtual machine 2000 and 2002, on different displayers.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

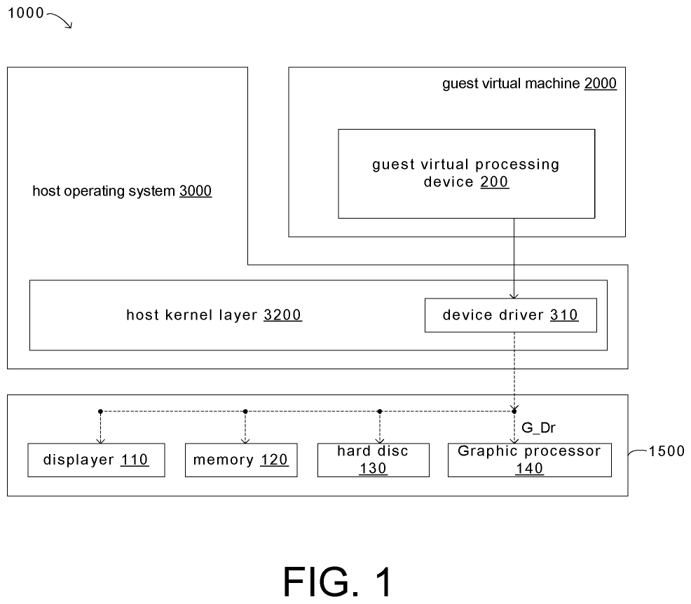

FIG. 1 is a schematic diagram illustrating a guest virtual machine (“guest VM”) 2000 operates in a computing device 1000. The guest virtual machine 2000 may be deployed on the computing device 1000, and the guest virtual machine 2000 may control and access a physical device 1500 of the computing device 1000 through a host kernel layer 3200 of the host operating system (“host OS”) 3000. Accordingly, the guest virtual machine 2000 serves as a second operating system to operate in the computing device 1000.

In one example, the computing device 1000 is, for example, a personal or household laptop computer, and the host operating system 3000 is, for example, the Microsoft Windows version 11 (“Windows 11”) installed in the computing device 1000 by default. The guest virtual machine 2000 is, for example, the “Linux” operating system installed by the user. The installed “Linux” operating system may control and access the physical devices 1500, such as the displayer 110, the memory 120, the hard disk 130 and the graphic processor (“GPU”) 140.

Moreover, the device driver 310 of the host kernel layer 3200 may provide a graphic processor driver G_Dr, which is used to drive the graphic processor 140 in the physical devices 1500 to perform drawing and graphic acceleration processing. The graphic processor 140 may draw the operating interface 2100 of the guest virtual machine 2000 and display the operating interface 2100 on the displayer 110. The guest virtual processing device 200 of this disclosure may be installed in the guest virtual machine 2000. When the host operating system 3000 concurrently operates with the guest virtual machine 2000 in the computing device 1000, the guest virtual processing device 200 may be used to control display allocation of the operating interface 2100 of the guest virtual machine 2000, and to control display switching of the host operating system 3000 and the guest virtual machine 2000.

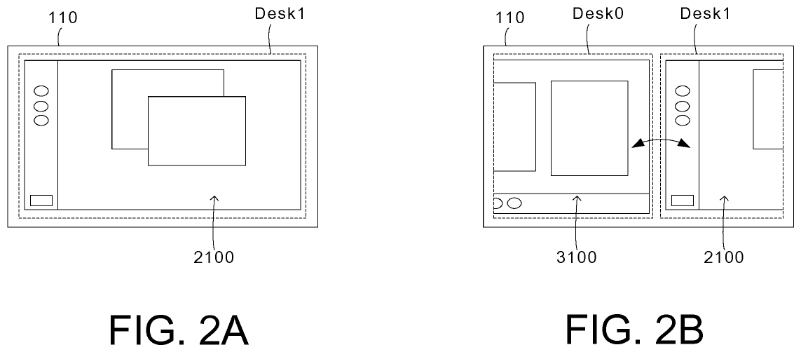

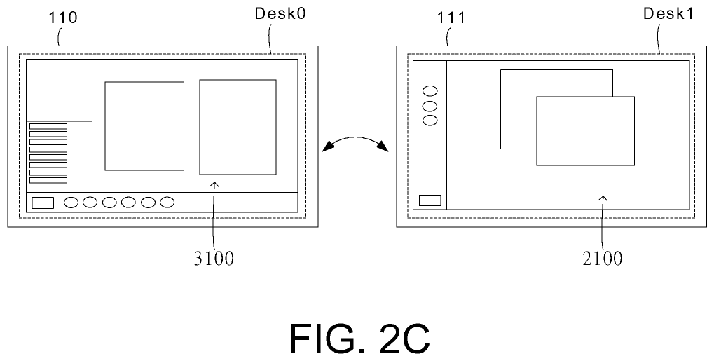

FIG. 2A is a schematic diagram illustrating the operating interface 2100 of the guest virtual machine 2000 is displayed on the displayer 110. Referring to FIG. 2A, the guest virtual machine 2000 may be referred to as the “first guest virtual machine”, and its operating interface 2100 may be referred to as the “first operating interface”. The operating interface 2100 is, for example, a graphical user interface (“GUI”), and the displayer 110 is, for example, a default displayer of the computing device 1000. The guest virtual processing device 200 may be used to control the displaying of the operating interface 2100 on the displayer 110. For example, the guest virtual processing device 200 may be used for intermediary processing on the transmission or conversion of control commands and applications between the guest virtual machine 2000 and the host operating system 3000. The guest virtual processing device 200 may also request physical resources and virtual resources of the computing device 1000 to be allocated to the guest virtual machine 2000, and a dedicated virtual desktop Desk1 is created for the guest virtual machine 2000 (i.e., the virtual desktop Desk1 may be referred to as the “first virtual desktop”). The guest virtual processing device 200 may control the operating interface 2100 to be displayed on the entire virtual desktop Desk1 of the displayer 110 with full-screen, instead of partially displaying the operating interface 2100 in a window of the displayer 110. Accordingly, when the user operates the guest virtual machine 2000 through the operating interface 2100, the user may also have a complete operating experience of with full-screen (i.e., a complete experience similar to operating the host operating system 3000).

FIGS. 2B and 2C are schematic diagrams illustrating display switching between the operating interface 2100 of the guest virtual machine 2000 and the host operating interface 3100 of the host operating system 3000. Please refer to FIG. 2B first, the user may simultaneously operate the host operating system 3000 and the guest virtual machine 2000 in the computing device 1000, and may switch to display the host operating system 3000 and the guest virtual machine 2000 at any time. For example, the host operating interface 3100 of the host operating system 3000 may be displayed on the default desktop Desk0, and the operating interface 2100 of the guest virtual machine 2000 may be displayed on the virtual desktop Desk1. In the same displayer 110, the user may switch from the host operating interface 3100 of the default desktop Desk0 to the operating interface 2100 of the virtual desktop Desk1 (and vice versa) at any time, and the above-mentioned operating may be performed at any time without rebooting the computing device 1000. For example, during the operation of the computing device 1000, the user may switch to display operating interface 2100 and the host operating interface 3100 by sliding the touch panel with fingers at any time, without rebooting the computing device 1000.

On the other hand, referring to the example of FIG. 2C, besides the default displayer 110, the computing device 1000 may be further connected to another external displayer 111. The host operating system 3000 may allocate the default desktop Desk0 to the default displayer 110, so as to display the host operating interface 3100 on the default desktop Desk0 of the default displayer 110. Moreover, the host operating system 3000 may allocate the virtual desktop Desk1 on the external displayer 111, so as to display the operating interface 2100 of the guest virtual machine 2000 on the virtual desktop Desk1 of the external displayer 111. From the above, the user may operate the host operating system 3000 and the guest virtual machine 2000 respectively through the default desktop Desk0 of the displayer 110 and the virtual desktop Desk1 of the external displayer 111 concurrently. Furthermore, the user may switch the host operating interface 3100 of the default desktop Desk0 to display on the external displayer 111, and switch the operating interface 2100 of the virtual desktop Desk1 to display on the default displayer 110. The user may perform the switching shown in FIG. 2C at any time during operation of the computing device 1000, without rebooting the computing device 1000. Smooth switching of the host operating interface 3100 and the operating interface 2100, may be achieved by the guest virtual processing device 200, and the user may thus have a good operating experience.

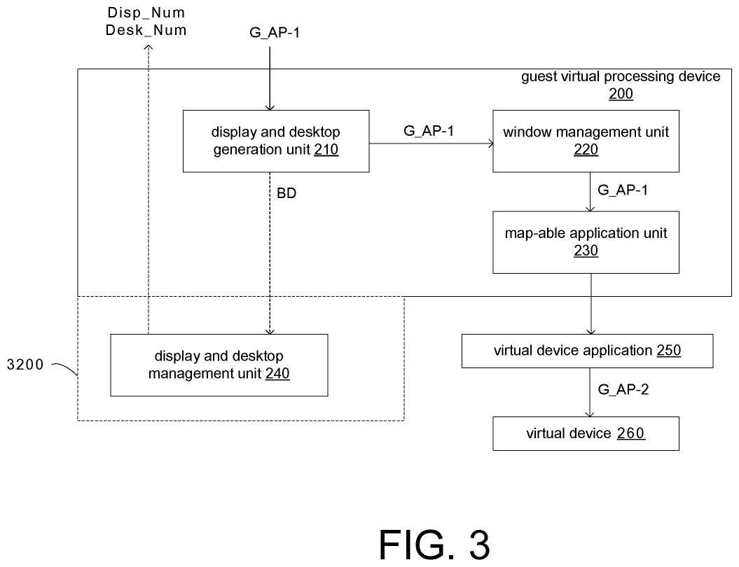

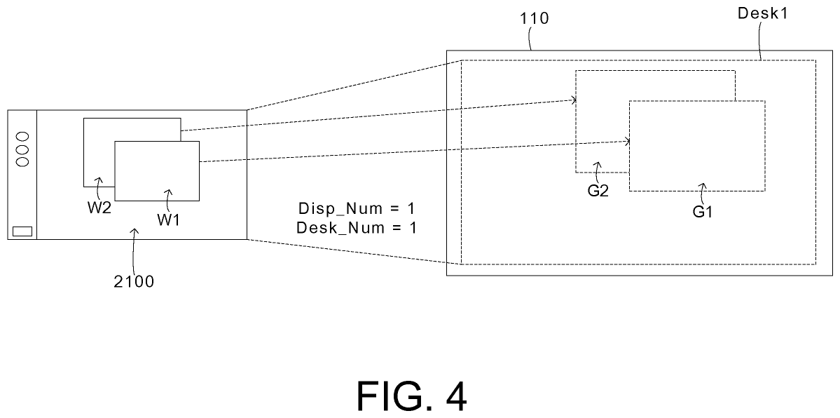

FIG. 3 is a block diagram of a guest virtual processing device 200 according to an embodiment of the present disclosure, and FIG. 4 is a schematic diagram illustrating display allocation of the operating interface 2100 of the guest virtual machine 2000 controlled by the guest virtual processing device 200. Please refer to FIGS. 3 and 4, the guest virtual processing device 200 includes a display and desktop generation unit 210, a window management unit 220, a map-able application unit 230 and a display and desktop management unit 240. Wherein, the display and desktop management unit 240 may be allocated in the host kernel layer 3200 of the host operating system 3000. In this embodiment, the guest virtual processing device 200 controlling the operating interface 2100 to be displayed on the virtual desktop Desk1 of the default displayer 110, is taken as an example.

The display and desktop generation unit 210 may operate based on a role of “display server” of the guest virtual machine 2000. A graphic application G_AP-1 is received by the display and desktop generation unit 210 through a guest desktop environment (not shown in FIG. 3) of the guest virtual machine 2000. The graphic application G_AP-1 is used to generate a graphic application G_AP-2 that may be parsed and executed by a virtual device 260 (“vDevice”). The virtual device 260 is a virtual resource corresponding to the physical graphic processor 140, and the virtual device 260 may execute graphic processing to draw the operating interface 2100 according to the graphic application G_AP-2. The display and desktop generation unit 210 transmits the graphic application G_AP-1 to the window management unit 220 and executes a communication procedure with the window management unit 220.

During the communication procedure between the display and desktop generation unit 210 and the window management unit 220, the window management unit 220 may determine a display position of the operating interface 2100 on the virtual desktop Desk1 of the displayer 110. The window management unit 220 may further set the display position of each object of the operating interface 2100. For example, the operating interface 2100 may include a window W1 and a window W2, and the window management unit 220 may set the window W1 and the window W2 to be displayed at a display position G1 and a display position G2 of the virtual desktop Desk1 respectively.

After the window management unit 220 completes the setting of the display position of the operating interface 2100, the display and desktop generation unit 210 may generate a virtual desktop creation command BD, and send the virtual desktop creation command BD to the display and desktop management unit 240 in the host kernel layer 3200. Moreover, the display and desktop management unit 240 makes a request to the host operating system 3000 according to the virtual desktop creation command BD, requesting to create a virtual desktop Desk1 on the displayer 110, and then display the operating interface 2100 on the virtual desktop Desk1 with full-screen.

After the host operating system 3000 creates the virtual desktop Desk1, the host operating system 3000 may assign the display number Disp_Num to the displayer 110, and assign the desktop number Desk_Num to the virtual desktop Desk1. For example, the display number Disp_Num of the displayer 110 is set to “1”, and the desktop number Desk_Num of the virtual desktop Desk1 is also set to “1”, that is, Disp_Num=1 and Desk_Num=1. Then, the display and desktop management unit 240 may set the display number Disp_Num as “1” and set the desktop number Desk_Num as “1” in the guest desktop environment of the guest virtual machine 2000. In contrast, the desktop number Desk_Num of the host operating interface 3100 of the host operating system 3000 is set as “0”.

Moreover, the display and desktop management unit 240 may detect whether the user logs out the guest virtual machine 2000. The display number Disp_Num of “1” and the desktop number Desk_Num of “1” of the guest virtual machine 2000 may be repealed, which is informed to the host operating system 3000 by the display and desktop management unit 240, such that the physical resources (i.e., the displayer 110 and the graphic processor 140) and the corresponding virtual resources (i.e., the virtual device 260) are returned to the host operating system 3000.

In addition, the map-able application unit 230 is used to map the graphic application G_AP-1 to the virtual device application 250, such that the virtual device application 250 may provide graphic application G_AP-2 which may be parsed and executed by the virtual device 260. From the above, the virtual device 260 may draw the operating interface 2100 according to the graphic application G_AP-2, the display number Disp_Num of “1” and the desktop number Desk_Num of “1” and the display position determined by the window management unit 220. The operating interface 2100 is completely displayed on the entire virtual desktop Desk1 of the displayer 110 with full-screen.

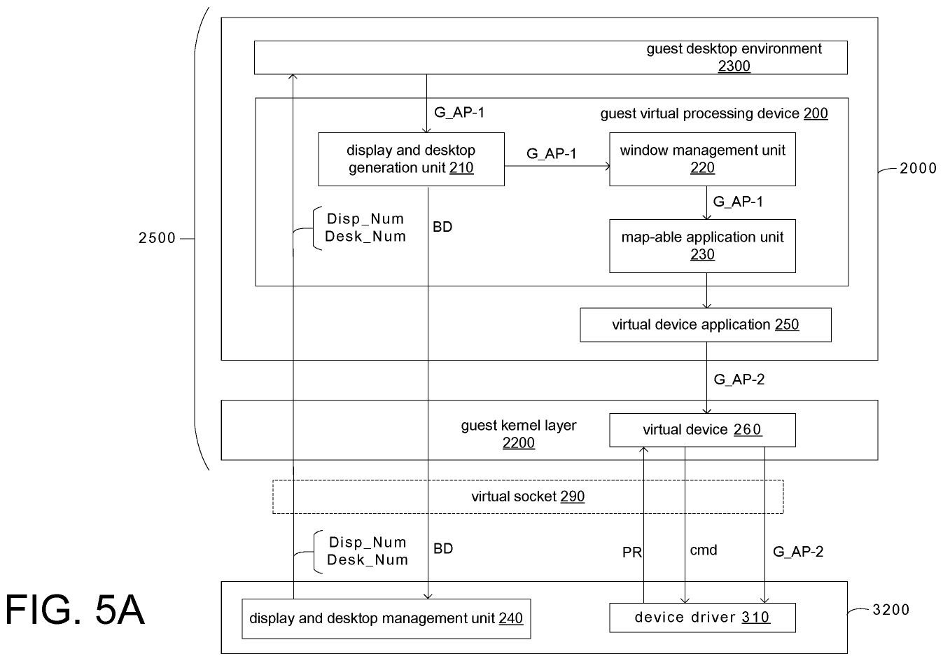

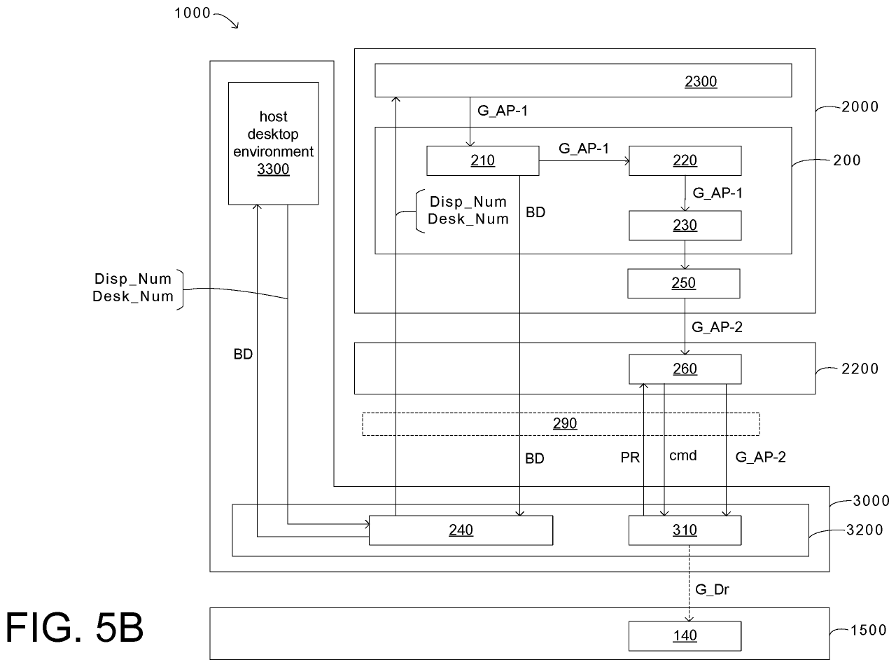

FIG. 5A is a block diagram of a guest virtual machine 2000, a guest kernel layer 2200 and a host kernel layer 3200, and FIG. 5B is a block diagram of a guest virtual machine 2000, a host operating system 3000 and physical devices 1500. FIGS. 5A and 5B shows the structure of the software/hardware stack composed of the guest virtual machine 2000, the host operating system 3000 and the physical devices 1500 in the computing device 1000. Please refer to both FIGS. 5A and 5B, the guest desktop environment 2300, the guest virtual processing device 200 and the virtual device application 250 are all allocated or disposed in the guest virtual machine 2000, the virtual device 260 is allocated or disposed in the guest kernel layer 2200, furthermore, the display and desktop management unit 240 and the device driver 310 are allocated or disposed in the host kernel layer 3200. The guest kernel layer 2200 is allocated between the guest virtual machine 2000 and the host kernel layer 3200. The software stack 2500 composed of the guest virtual machine 2000 and the guest kernel layer 2200 is, for example, the “Windows Subsystem for Linux-II (WSL2)” provided by the Microsoft Windows operating system.

Before the operating interface 2100 of the guest virtual machine 2000 is displayed on the virtual desktop Desk1, the guest desktop environment 2300 is initialized. During the initialization process, the guest desktop environment 2300 outputs the graphical application G_AP-1 to the display and desktop generation unit 210. The display and desktop generation unit 210 communicates with the window management unit 220, and the window management unit 220 determines the display position of the operating interface 2100 on the virtual desktop Desk1, and then the display and desktop generation unit 210 generates the virtual desktop creation command BD. Moreover, the guest virtual processing device 200 creates a virtual socket (“vSocket”) 290 between the guest kernel layer 2200 and the host kernel layer 3200, and transmits the virtual desktop creation command BD to the display and desktop management unit 240 in the host kernel layer 3200, through the virtual socket 290.

On the other hand, the host operating system 3000 also allocate a host desktop environment 3300, and the display and desktop management unit 240 may transmit the virtual desktop creation command BD to the host desktop environment 3300. In operation, the host desktop environment 3300 may serve as a management center for distributing physical displayers and virtual desktops. In response to the request of the virtual desktop creation command BD of the guest virtual processing device 200, the host desktop environment 3300 creates a virtual desktop Desk1 on the displayer 110. Moreover, the host desktop environment 3300 assigns the display number Disp_Num of “1” and the desktop number Desk_Num of “1” to the displayer 110 and the virtual desktop Desk1. In addition, the host desktop environment 3300 may set the display number Disp_Num of “1” and the desktop number Desk_Num of “1” in the guest desktop environment 2300 of the guest virtual machine 2000 through the display and desktop management unit 240.

Furthermore, the map-able application unit 230 maps the graphic application G_AP-1, so that the virtual device application 250 provides the graphic application G_AP-2 that may be mapped to the virtual device 260. And, the virtual device 260 transmits the graphic application G_AP-2 and the control command cmd to the device driver 310 through the virtual socket 290, and the device driver 310 further provides the graphic processor driver G_Dr to the graphic processor 140 of the physical devices 1500. Correspondingly, the host operating system 3000 may give the virtual device 260 sufficient privilege to process the drawing and displaying of the operating interface 2100. In one example, the device driver 310 of the host kernel layer 3200 may send a control signal PR to the virtual device 260 to enable the access privilege of the virtual device 260. Accordingly, the virtual device 260 (associated with the guest virtual machine 2000) may obtain sufficient privilege from the host operating system 3000, and the physical graphic processor 140 corresponding to the virtual device 260 may perform drawing and graphic acceleration processing according to the graphic processing driver G_Dr. Hence, the operating interface 2100 of the guest virtual machine 2000 may be displayed on the virtual desktop Desk1 of the displayer 110 with full-screen.

In the technical solution of this disclosure, the guest virtual processing device 200 may create a dedicated virtual socket 290 to transmit or receive the virtual desktop creation command BD, the graphic application G_AP-2, the control command cmd and the control signal PR from the host kernel layer 3200, so as to increase the transmission speed of the virtual desktop creation command BD, the graphic application G_AP-2, the control command cmd and the control signal PR. Hence, the physical graphic processor 140 may execute drawing and graphic acceleration in a real-time manner. Accordingly, when the user switches from the originally displayed host operating interface 3100 to the operating interface 2100 of the guest virtual machine 2000, the physical graphic processor 140 may draw the operating interface 2100 in real time to improve the fluency of display switching.

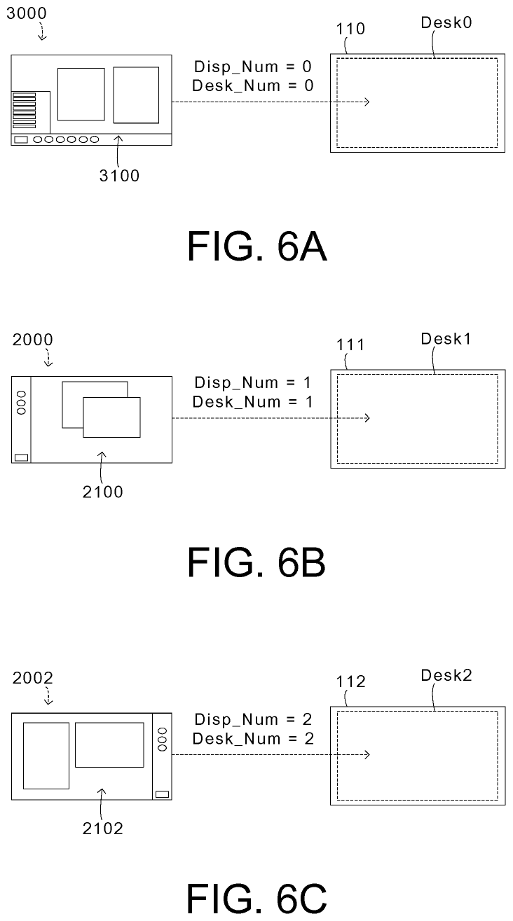

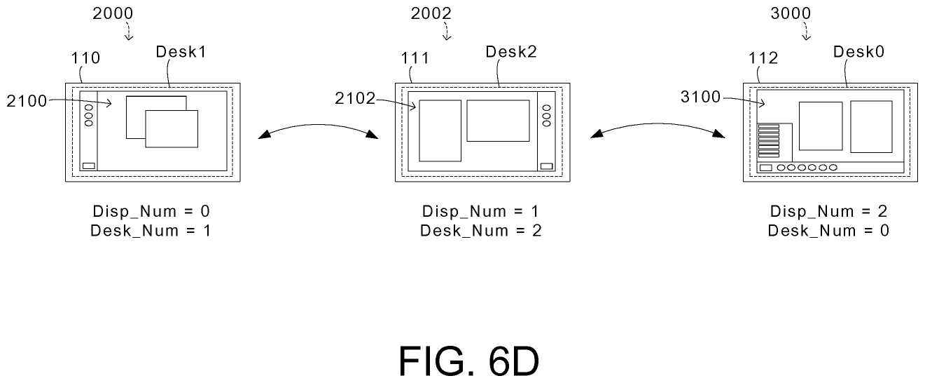

On the other hand, in the technical solution of this disclosure, more than two guest virtual machines may be concurrently executed in the computing device 1000, for example, the host operating system 3000 is concurrently executed with the guest virtual machine 2000 and the guest virtual machine 2002. FIGS. 6A-6C are schematic diagrams showing respective operating interfaces 3100, 2100 and 2102 of the host operating system 3000, the guest virtual machine 2000 and the guest virtual machine 2002 are respectively displayed on different displayers and different virtual desktops of the computing device 1000. Please refer to FIGS. 6A-6C, the guest virtual machine 2000 may be referred to as a “first guest virtual machine” and the guest virtual machine 2002 may be referred to as a “second guest virtual machine”. In one example, the guest virtual machine 2000 is a “Linux” operating system, the guest virtual machine 2002 is a “Ubuntu” operating system. Moreover, the operating interface 2100 of the guest virtual machine 2000 may be referred to as a “first operating interface”, and the operating interface 2102 of the guest virtual machine 2002 may be referred to as a “second operating interface”. In addition to the default displayer 110, the computing device 1000 is further connected to an external displayer 111 (referred to as a “first external displayer”) and an external displayer 112 (referred to as a “second external displayer”). Moreover, a guest virtual processing device 202, which is similar to the guest virtual processing device 200, may also be disposed or allocated in the guest virtual machine 2002. The intermediary processing of control commands, control signals, and graphic applications between the guest virtual machines 2000, 2002 and the host operating system 3000, may be performed by the guest virtual processing devices 200 and 202. Hence, the operating interfaces 3100, 2100 and 2102 may concurrently operate and display on the displayers 110, 111 and 112 respectively.

In operation, the host desktop environment 3300 of the host operating system 3000 may assign the display number Disp_Num of “0” to the default displayer 110, and assign the desktop number Desk_Num of “0” to the default desktop Desk0. According to the display number Disp_Num of “0” and the desktop number Desk_Num of “0”, the host operating interface 3100 is displayed on the default desktop Desk0 of the default displayer 110.

On the other hand, the host desktop environment 3300 may assign the display number Disp_Num of “1” to the external displayer 111, and assign the display number Disp_Num of “2” to the external displayer 112. In addition, the host desktop environment 3300 may assign the desktop number Desk_Num of “1” to the virtual desktop Desk1, and assign the desktop number Desk_Num of “2” to another virtual desktop Desk2. The virtual desktop Desk1 may be referred to as a “first virtual desktop”, and the virtual desktop Desk2 may be referred to as a “second virtual desktop”. From the above, according to the display number Disp_Num of “1” and the desktop number Desk_Num of “1”, the operating interface 2100 of the guest virtual machine 2000 is displayed on the virtual desktop Desk1 of the external displayer 111. Furthermore, according to the display number Disp_Num of “2” and the desktop number Desk_Num of “2”, the operating interface 2102 of the guest virtual machine 2002 is displayed on the virtual desktop Desk2 of the external displayer 112.

In the embodiments of FIGS. 6A to 6C, the operating interfaces 3100, 2100 and 2102 are displayed on different displayers and different virtual desktops respectively. In other embodiments, the operating interfaces 3100, 2100 and 2102 may be switched to display on different displayers. Please refer to FIG. 6D, which is a schematic diagram illustrating display switching of the operating interfaces 3100, 2100 and 2102 of the host operating system 3000, the guest virtual machine 2000 and 2002, on different displayers. In operation, the guest virtual processing device 200 of the guest virtual machine 2000 may request the host desktop environment 3300 to assign the display number Disp_Num of “0” and the desktop number Desk_Num of “1” to the guest virtual machine 2000. Accordingly, the guest virtual processing device 200 may control the operating interface 2100 to switch displaying on the virtual desktop Desk1 of the default displayer 110. On the other hand, the guest virtual processing device 202 of the guest virtual machine 2002 may request the host desktop environment 3300 to assign the display number Disp_Num of “1” and the desktop number Desk_Num of “2” to the guest virtual machine 2002. Accordingly, the guest virtual processing device 202 may control the operating interface 2102 switch displaying on the virtual desktop Desk2 of the external displayer 111. Moreover, the host desktop environment 3300 correspondingly assigns the display number Disp_Num of “2” and the desktop number Desk_Num of “0” to the host operating system 3000. Accordingly, the host operating interface 3100 of the host operating system 3000 may switch displaying on the default desktop Desk0 of the external displayer 112.

To sum up, in the embodiments of this disclosure, displaying allocation for the operating interface 2100 of the guest virtual machine 2000 may be controlled by the guest virtual processing device 200, so that the operating interface 2100 may cooperate with the dedicated virtual desktop Desk1 to display in a full-screen manner, and complete full-screen operating experience may be obtained for the user. Moreover, under the control of the guest virtual processing device 200, the host operating interfaces 3100 and 2100 may be switched at any time, without rebooting the computing device 1000. Hence, user's seamless switching experience may be achieved. In addition, the technical solution of this disclosure may execute more than two guest virtual machines concurrently, and operating interfaces of these guest virtual machines may be switched.

It will be apparent to those skilled in the art that various modifications and variations may be made to the disclosed embodiments. It is intended that the specification and examples be considered as exemplary only, with a true scope of the disclosure being indicated by the following claims and their equivalents.

What is claimed is:

1. A virtual processing device, for controlling a displaying of a first operating interface of a first guest virtual machine, the virtual processing device comprising:
a display and desktop generation unit, for receiving a graphic application and generating a virtual desktop creation command, the virtual desktop creation command is used to create a first virtual desktop to display the first operating interface with full-screen;
a window management unit, for setting a display position at which the first operating interface is displayed on the first virtual desktop, according to the graphic application; and
a display and desktop management unit, for setting a display number and a desktop number related to the first guest virtual machine according to the virtual desktop creation command, the desktop number corresponds to the first virtual desktop,
wherein, the first guest virtual machine concurrently operates with a host operating system, the host operating system has a host operating interface displayed on a default desktop, and the first operating interface and the host operating interface are switched to display on at least one displayer.

2. The virtual processing device according to claim 1, wherein the first guest virtual machine concurrently operates with the host operating system on a computing device, when the first operating interface and the host operating interface are switched to display on the at least one displayer, the computing device needs not to reboot.

3. The virtual processing device according to claim 1, further comprising:
a map-able application unit, for mapping the graphic application to a virtual device application;
wherein, the virtual device application is used to execute a virtual device of the first guest virtual machine to draw and display the first operating interface on the first virtual desktop.

4. The virtual processing device according to claim 3, wherein the graphic application, which is mapped, is sent to a device driver of the host operating system through the virtual device, and the device driver enables an access privilege of the virtual device.

5. The virtual processing device according to claim 4, wherein the device driver is used to provide a graphic processor driver to drive a graphic processor, and the graphic processor is a physical device corresponding to the virtual device, and the graphic processor is used to draw and display the first operating interface.

6. The virtual processing device according to claim 4, wherein the virtual device is disposed in a guest kernel layer, and the guest kernel layer is related to the first guest virtual machine.

7. The virtual processing device according to claim 4, wherein the device driver and the display and desktop management unit are disposed in a host kernel layer, and the host kernel layer is related to the host operating system.

8. The virtual processing device according to claim 4, wherein the graphic application, which is mapped, is sent to the device driver through a virtual socket.

9. The virtual processing device according to claim 1, wherein a host desktop environment of the host operating system assigns the display number and the desktop number to the first guest virtual machine, and the display and desktop management unit transmits the display number and the desktop number to a guest desktop environment of the first guest virtual machine.

10. The virtual processing device according to claim 9, wherein the first virtual desktop and the default desktop are allocated on a default displayer, the first operating interface and the host operating interface are switched to display on the default displayer according to the display number and the desktop number.

11. The virtual processing device according to claim 9, wherein the first virtual desktop is allocated on a first external displayer, and the default desktop is allocated on a default displayer, the first operating interface and the host operating interface are switched to display on the first external displayer and the default displayer according to the display number and the desktop number.

12. The virtual processing device according to claim 9, wherein the host desktop environment further creates a second virtual desktop for a second guest virtual machine, and the second guest virtual machine has a second operating interface displayed on the second virtual desktop with full-screen.

13. The virtual processing device according to claim 12, wherein the first virtual desktop, the second virtual desktop and the default desktop are allocated on a default displayer, the first operating interface, the second operating interface and the host operating interface are switched to display on the default displayer according to the display number and the desktop number.

14. The virtual processing device according to claim 12, wherein the first virtual desktop is allocated on a first external displayer, the second virtual desktop is allocated on a second external displayer, and the default desktop is allocated on a default displayer, the first operating interface, the second operating interface and the host operating interface are switched to display on the first external displayer, the second external displayer and the default displayer according to the display number and the desktop number.
